(19) United States
(12) Patent Application Publication
(10) Pub. No.: US 2008/0011407 A1
(43) Pub. Date: Jan. 17, 2008

(54) New glass

(76) Inventor: Gregory Alan Reeves, Fullerton, CA (US)

Correspondence Address: GREGORY ALAN REEVES, 224 EAST COMMONWEALTH ST., APT.# 421, FULLERTON, CA, 92832, US

(21) Appl. No.: 11/487,279

(22) Filed: Jul. 17, 2006

(51) Int. Cl. C03B 23/00

(52) U.S. Cl. 156/94

(57) ABSTRACT

The formula of my invention is one-fourth soda, one eighth cerium oxide (that Is precipitated) one-eighth limestone, one sixteenth white distilled vinegar (that Is also precipitated) one sixteenth of potash to give the mixture an abrasive texture Along with one sixteenth portion of sawdust. Mixed with this mixture is water to Thicken the mixture into a paste compound. The now thickened compound is applied to the affected area of the glass (the Scratched area). Give the compound 30 to 40 seconds to dry on the glass. The consumer now follows the instructions I have already outlined in the Specification of this invention.

### BACKGROUND OF THE INVENTION

My invention will allow laypersons to repair, and restore scratched, etched upon Glass by vandals, which will save the user of my invention thousands of dollars in Glass replacement costs.

### BRIEF SUMMARY OF THE INVENTION

My invention is composed of a compound, required tools, as well as a specific Step by step process, involving the use of again required third party tools (such As a polisher).

There is, and has been an existing problem for small business owners that still exists In the extreme cost of replacing store-front glass etched by vandals. My invention will get rid of this old problem with a new solution, my invention.

### SPECIFICATION

The pragmatic use of this invention is to rid deeply scratched glass from graffiti Etching, and or vandalism.

The invention consist of applying chemicals (described in the abstract of the Disclosure) to the affected areas of the glass (and or mirror) before and after The process is done.

First the consumer is instructed via easy to follow instructions to apply the first Chemicals which are labeled in a plastic container labeled One A. After applying the Paste like chemical, the consumer is instructed to apply a sandpaper disc Labeled “one”. This is a very coarse grade of sandpaper that has been chemically Treated by Worldwide Labs.

After the scratch is removed, there will be left a haze (white). The consumer is Instructed to remove the coarse (one) sandpaper from the power tool provided in The kit and apply the second disc labeled “two”. The consumer is instructed to Apply the power tool to the glass laying the tool flat against the glass checking every Three seconds that the glass is clear.

After the glass is clear, the consumer is instructed to apply the wool polishing pad Also supplied in the kit to the power tool. The consumer is now instructed to Apply the chemical labeled (Two B) to the glass to be polished. After the Two B chemical has been applied the consumer is instructed to polish (buff) The glass.

The invention can also be used on glass that has light scratches, acid based graffiti Paint (used by gang members) stains, and glass that is weather beaten. When removing light scratches, stains and acid based paint no power tool is Required.

1. What I claim as my invention is that there is NO formula, compound, or pragmatic Solution on the open market that can rid glass, and or mirrors of DEEPLY ENGRAVED scratches (graffiti) from glass.

2. Sommaca (one of the oldest And most reputable companies in the glass industry since 1920) sells a mechanical apparatus from there catalog dated 2006 on page 30 that gives and shows An example of what their apparatus cannot do. The tool cannot remove DEEP SCRATCHES FROM GLASS, MY INVENTION CAN.

3. The pragmatic use of my invention is to rid mirrors, and or any glass surface of Deep scratches.

4. My invention is a composed of a combination of chemicals that when applied CORRECTLY in the correct proportion produces from proper proportioned Reactants a product that along with chemically treated (my invention) sandpaper, Along with the tool provided in my process (a special sanding tool).
